(19) United States
(12) Patent Application Publication
(10) Pub. No.: US 2016/0161417 A1
(43) Pub. Date: Jun. 9, 2016

(54) Super-Sensitive and Stable Gold Nanoparticles

(71) Applicants: Vidya Shimoga Muddappa, Nitte (IN); Pradeepa, Nitte (IN); Vaman Chandrayan Rao, Nitte (IN)

(72) Inventors: Vidya Shimoga Muddappa, Nitte (IN); Pradeepa, Nitte (IN); Vaman Chandrayan Rao, Nitte (IN)

(21) Appl. No.: 14/544,897

(22) Filed: Mar. 4, 2015

(30) Foreign Application Priority Data
Dec. 8, 2014 (IN) 6186/CHE/2014

(51) Int. Cl. G01N 21/78

(52) U.S. Cl. CPC G01N 21/78

(57) ABSTRACT

A medium comprising AuNPs and a pre bonded ascorbic acid and sodium borohydride (AA-BH) capped onto larger number of the AuNPs in the medium, wherein the pre bonded AA-BH prevents aggregation of the AuNPs in the medium is provided in the present disclosure. In one embodiment, the method for synthesizing AuNPs and capping of the same with AA-BH is provided. In another embodiment, infrared light absorption characteristics at different wavelengths are determined for the synthesized AuNPs which represents the capping of AA-BH onto them. The AuNPs synthesized in the present disclosure are more stable and capable to sense lower concentration of various substances.

### CROSS REFERENCES TO RELATED APPLICATIONS

This application claims priority from Indian patent application No. 6186/CHE/2014 filed on Dec. 8, 2014 which is incorporated herein in its entirety by reference.

### BACKGROUND

1. Technical Field

Embodiments of the present disclosure relate generally to gold nanoparticles and more specifically to stable and highly sensitive gold nanoparticles.

2. Related Art

Gold nanoparticles (hereafter represents as AuNPs) are versatile materials having a wide variety of applications in various fields of technology. The physicochemical properties of the AuNPs are critically dependent on their size, shape and distribution.

Although various conventional methods for synthesizing AuNPs are known to the art, all, or almost all of these methods are time consuming and are complicated as they need extreme conditions such as high temperature and pressure, organic solvents and pH.

Previous studies demonstrated that AuNPs are synthesized by reducing a gold salt with a reducing agent in addition with other supplementary agents. In one example, AuNPs are synthesized by reducing chloroauric acid (HAuCl₄) with citrate as a reducing and capping agent.

However, the AuNPs synthesized by conventional reduction process have poor sensitivity in detecting low concentration of metals, organic compounds, biological substances and other contaminants (hereafter all these terms together are referred to as substances). The sensitivity of AuNPs depends on various factors like size, shape, distribution, biocompatibility, stability and capping of supplementary agents.

Often, conventionally synthesized AuNPs are limited to detect only few substances due to their inefficient bonding of reducing agents to gold particles. Further, sensing the substances in water involves multi-step process and in many cases it takes number of hours and/or days to determine a result.

Therefore, it is required to synthesize AuNPs that are stable and sensitive to lower level of the substances in water and method to produce such AuNPs.

### SUMMARY

According to an aspect of the present disclosure, a medium comprising AuNPs and pre bonded ascorbic acid and sodium borohydride (AA-BH) capped onto larger number of the AuNPs in the medium, wherein the pre bonded AA-BH prevents aggregation of the AuNPs in the medium. In one embodiment, the AuNPs are prepared from HauCl₄ by the pre bonded AA-BH in the medium.

According to another aspect of the present disclosure, the method for synthesizing AuNPs and capping of the same with AA-BH is provided. In another embodiment, infrared light absorption characteristics at different wavelengths are determined for the synthesized AuNPs which represents the capping of AA-BH onto them. The AuNPs synthesized in the present disclosure are more stable and capable to sense lower concentration of various substances.

Several embodiments are described below, with reference to the diagrams for illustration. It should be understood that numerous specific details are set forth to provide a full understanding of the invention. One skilled in the relevant art, however, will readily recognize that embodiments may be practiced without one or more of the specific details, or with other methods, etc. In other instances, well-known structures or operations are not shown in detail to avoid obscuring the features of the invention.

### BRIEF DESCRIPTION OF DRAWINGS

FIG. 1A is a schematic diagram illustrating highly sensitive and stable AuNPs in one embodiment of the present disclosure.

FIG. 1B is a block diagram illustrating the synthesis of AuNPs in another embodiment of the present disclosure.

FIG. 2A is a block diagram illustrating micrograph of synthesized AuNPs using transmission electron microscopy (TEM) in another embodiment of the present disclosure.

FIGS. 2B through 2E are the block diagrams illustrating Fourier Transform Infrared spectroscopy (FTIR) spectra of AA-BH-AuNPs, AA-BH mixture, BH-AuNPs and AA-AuNPs respectively in another embodiment of the present disclosure.

FIG. 3A illustrates UV-visible spectra of AA-BH-AuNPs (301), BH-AuNPs (302) and AA-AuNPs (303) in another embodiment of the present disclosure.

FIG. 3B illustrates UV-visible spectra of AA-BH-AuNPs in another embodiment of the present disclosure.

FIG. 4A is a block diagram illustrating visual color change reaction of AuNPs in sensing different substances at different concentrations.

FIG. 4B is a schematic diagram illustrating the mechanism of visual color change of AuNPs in sensitivity test.

FIGS. 5A through FIG. 5C are the tables illustrating sensitivity of synthesized AuNPs against different substances in another embodiment of the present disclosure.

FIGS. 5D and 5E are UV-visible spectra of AuNPs further depicting sensitivity of AuNPs in another embodiment of the present disclosure.

### DETAILED DESCRIPTION OF THE PREFERRED EXAMPLES

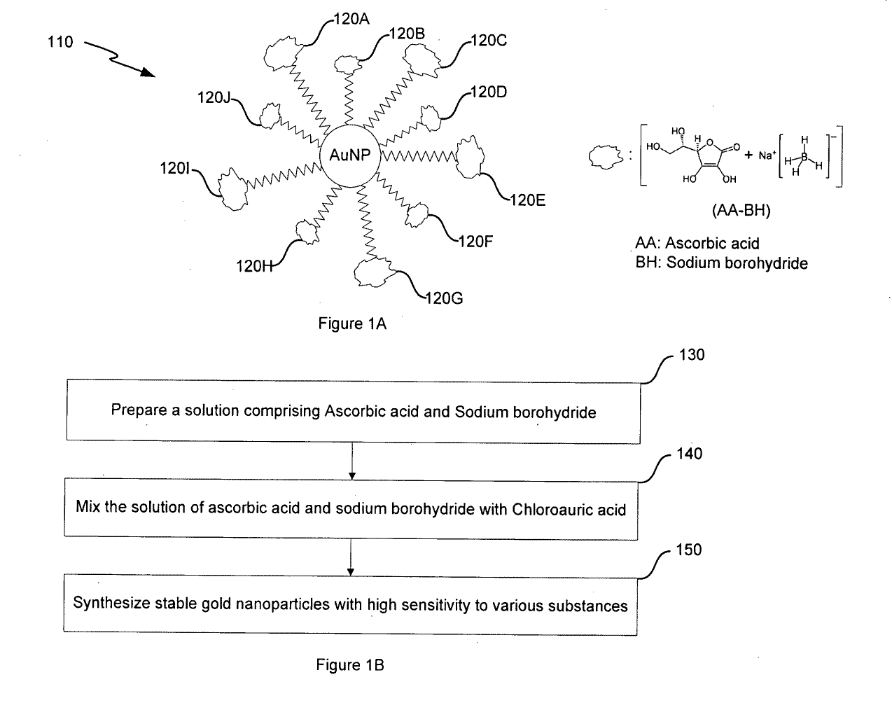

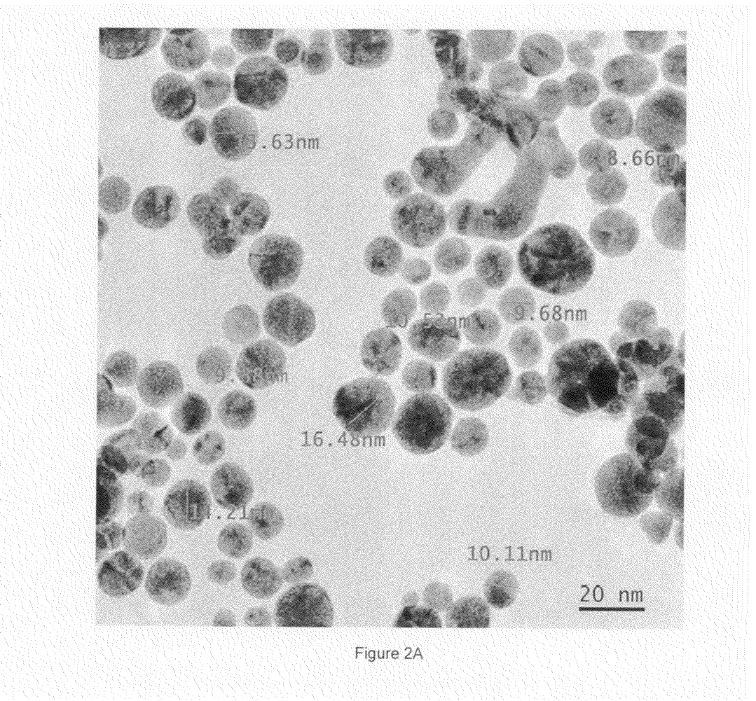

FIG. 1A is a schematic diagram illustrating highly sensitive and stable AuNPs in one embodiment of the present disclosure.

In one embodiment, highly sensitive and stable AuNPs (110) comprising a capping agent (120A through 120J) capped onto reduced AuNPs. The capping agent comprises at least one of ascorbic acid and sodium borohydride. Alternatively the capping agent may comprise ascorbic acid bonded with sodium borohydride. Due to the capping agent (120A through 120J) that comprises both ascorbic acid and sodium borohydride, the AuNPs (110) are sensitive and stable. The AuNPs may be synthesized by reducing HAuCl₄ with a reducing agent and then capped with a capping agent, wherein both the reducing and capping agents comprises of ascorbic acid and sodium borohydride (AA-BH) together. The ascorbic acid and sodium borohydride (AA-BH) together acts as a reducing as well as capping agent and forms a cap over the reduced AuNPs. The reduction and capping of AA-BH enhances the sensitivity and stability of the AuNPs (110). In one embodiment, the high sensitivity AuNPs comprise only AA or BH or AA-BH. Due to bonding and capping of only AA or BH or AA-BH and with no other elements, the AuNPs of the present disclosure exhibit high sensitivity and stability.

The AuNPs (110) thus synthesized are highly sensitive in detecting various substances present in a test sample. For example, the AuNPs (110) may be able to sense presence of minimal concentrations of substances comprising at least one of aluminum, antimony, barium, cadmium, chromium, copper, calcium, cobalt, iodine, lead, mercury, magnesium, manganese, nickel, sodium, selenium, potassium, zinc, penicillin, ampicillin, tetracycline, erythromycin, streptomycin, pesticide, ammonia, phenol, trichloroacetic acid (TCA), dimethyl sulfoxide (DMSO), ethanol, butanol, chlorobenzene, benzene, formic acid, formaldehyde, ethyl acetate, orthophosphoric acid, 2-propanol, toluene, hexane, acetic acid, nisin, bovine serum albumin (BSA), vegetable oil, 5-fluorouracil (5-FU), glucose, fructose, mannose, arabinose, sucrose, lactose, xylose, galactose, E. coli, E. aerogenes, NaCl, HCl, NaOH and other toxicants present in domestic sewage water, industrial water, detergent water, tap water, aqua water, packed water, distilled water and other water sources.

FIG. 1B is a block diagram illustrating the synthesis of AuNPs in another embodiment of the present disclosure.

In one embodiment of the present disclosure, AuNPs are produced by reducing HAuCl₄ with sodium borohydride as a strong reducing agent. The sodium borohydride is mixed with the HAuCl₄ or gold ion containing solution and refluxed for a predetermined time period for example, 2-5 minutes to produce AuNPs. The synthesized nanoparticles are unstable and are able to sense few metals and other contaminants.

In an alternative embodiment, AuNPs are produced by reducing the HauCl₄ with ascorbic acid as a reducing agent as well as capping agent. Capping agent protects the surface of nanoparticles from modifications due to the interactions with other nanoparticles. Although the synthesized AuNPs are stable, the size, shape distribution and sensing ability of nanoparticles are not as desired.

In yet another alternative embodiment, the sodium borohydride and the ascorbic acid are advantageously used together in synthesizing more sensitive and stable AuNPs.

In block 130, a solution (AA-BH) comprising different concentrations of ascorbic acid (AA) and sodium borohydride (BH) is prepared. For example, the AA concentration ranges from 5.6×10⁻⁴M to 56×10⁻² M wherein the BH concentration ranges from 1.321×10⁻² M to 3.321×10⁻² M. In one embodiment, the solution is prepared by mixing a calculated amount of 56×10⁻³ M ascorbic acid (AA) and 1.321×10⁻¹M sodium borohydride (BH) in deionized water.

In block 140, the solution AA-BH (from step 130) is mixed with aqueous gold at room temperature. For example, the solution AA-BH is mixed with HAuCl₄ solution. In one embodiment, a calculated amount of 1.5×10⁻³M HAuCl₄ solution is prepared in deionized water. 100 ml of HAuCl₄ solution is mixed with AA-BH solution from the step 130 comprising 40 ml AA and 2 ml BH.

In block 150, AuNPs are synthesized with AA-BH caps on their peripheral surfaces. On addition of AA-BH solution to HAuCl₄, a reduction reaction takes place with a change in color of the solution from light yellow to red. In one embodiment, poly-dispersed AuNPs are produced by reduction of HauCl₄ with a combination of AA-BH. In another embodiment, the combination of AA-BH further acts as a capping agent and enhances stability and sensitivity of the AuNPs. The synthesized AuNPs are stored at 4° C.

Thus the combination of ascorbic acid and sodium borohydride helps in reducing the HAuCl₄ into AuNPs wherein the same combination acts as a capping agent enhancing the stability and sensitivity of the AuNPs.

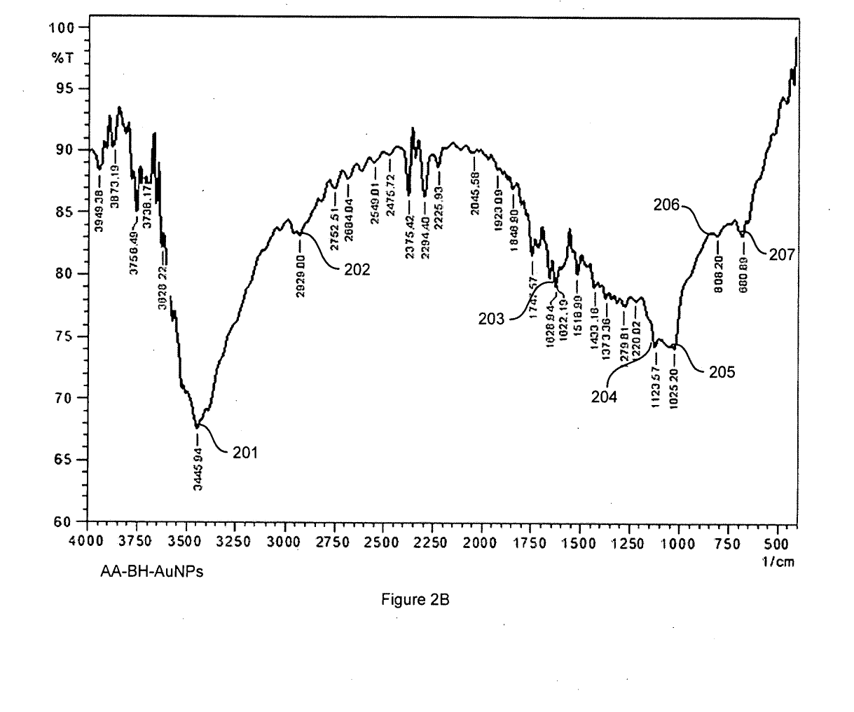

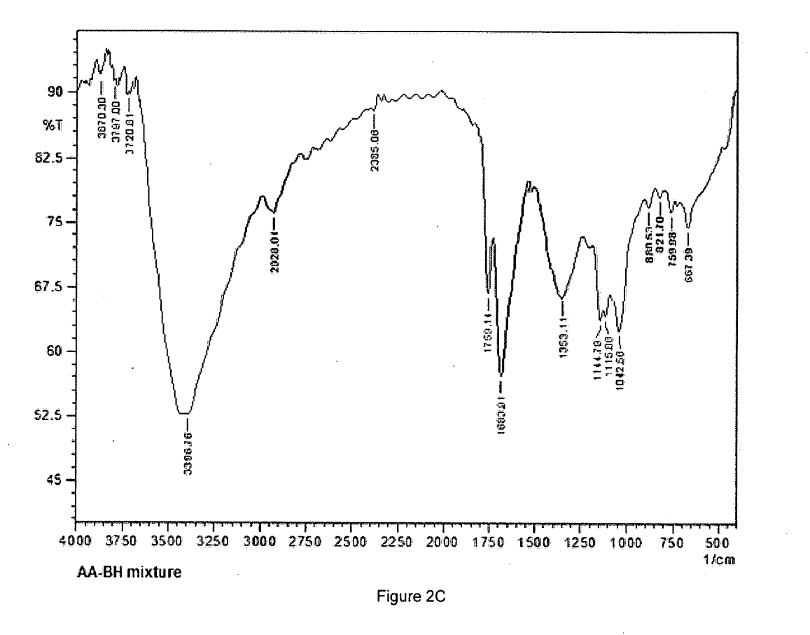

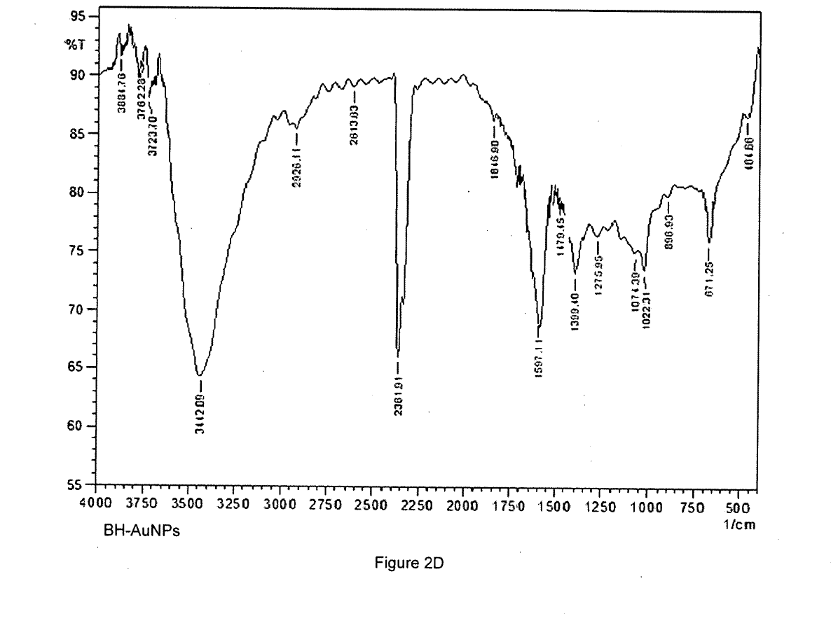

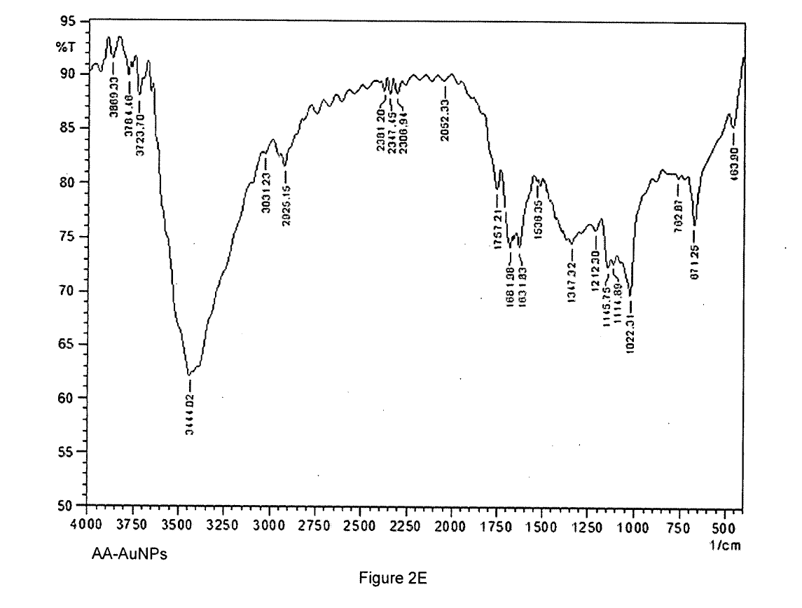

FIG. 2A through 2E further illustrates the AuNPs of the present disclosure.

FIG. 2A is a block diagram illustrating micrograph of synthesized AuNPs using transmission electron microscopy (TEM) in another embodiment of the present disclosure. The micrograph in the figure represents randomly distributed and spherical shaped AuNPs of the present disclosure. The average diameter of the synthesized AuNPs is determined as 16-20 nm. As the size of AuNPs is very small, they are more stable and sensitive to the various substances showing a shift in the λₘₐₓ and visual color change.

FIGS. 2B through 2E are the block diagrams illustrating Fourier Transform Infrared spectroscopy (FTIR) spectra of AA-BH-AuNPs, AA-BH mixture, BH-AuNPs and AA-AuNPs respectively in another embodiment of the present disclosure.

FIG. 2B illustrates the infrared (IR) spectra of AuNPs formed from AA-BH in one embodiment of the present disclosure. In the figure, the troughs 201 through 207 represent spectral variations indicating various functional groups present on the synthesized AuNPs. These spectral variations are formed due to interactions between AA-BH and the gold salt. The broad trough at 201 (3445.94 cm⁻¹) show the presence of O—H bond. The trough obtained at 202 (2929 cm⁻¹) may be one reason of the presence of C—H bonds whereas the troughs present at 203 (1628.94 cm⁻¹ and 1622.19 cm⁻¹) are may be due to the presence of C═O bond. The troughs present at 204 through 207 may comprise of functional groups having boron, carbon and hydrogen interactions.

FIG. 2C through 2E are the graphs illustrating IR spectra of AA-BH mixture, BH-AuNPs mixture and AA-AuNPs mixture respectively. The IR spectra of all chemical shifts from the figures are analyzed and compared with the IR spectra of AuNPs with reference to FIG. 2B. On analyzing, it is determined that AA-BH is capped onto peripheral surface of large number of the AuNPs.

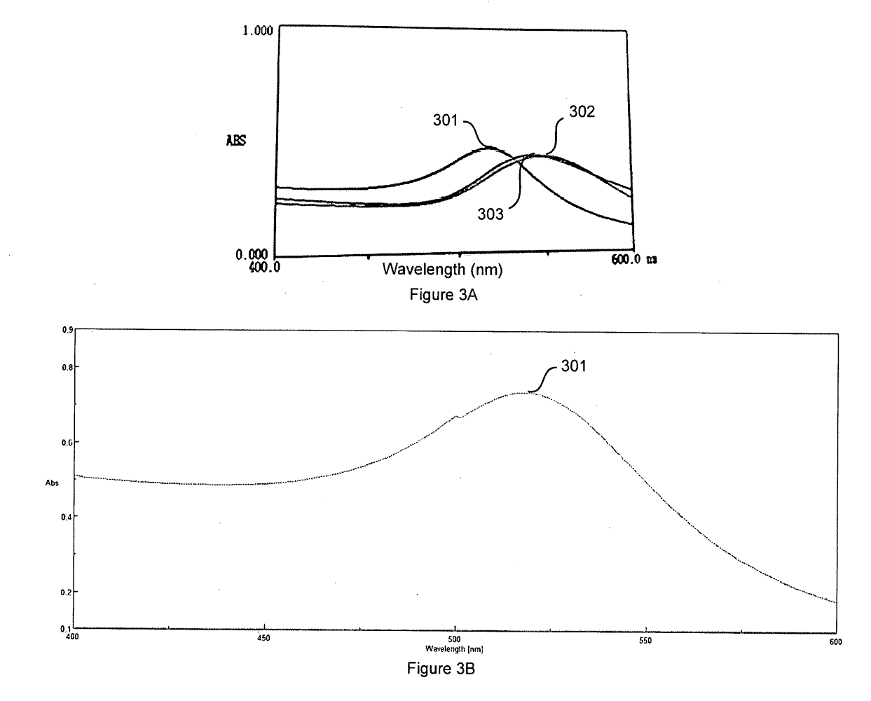

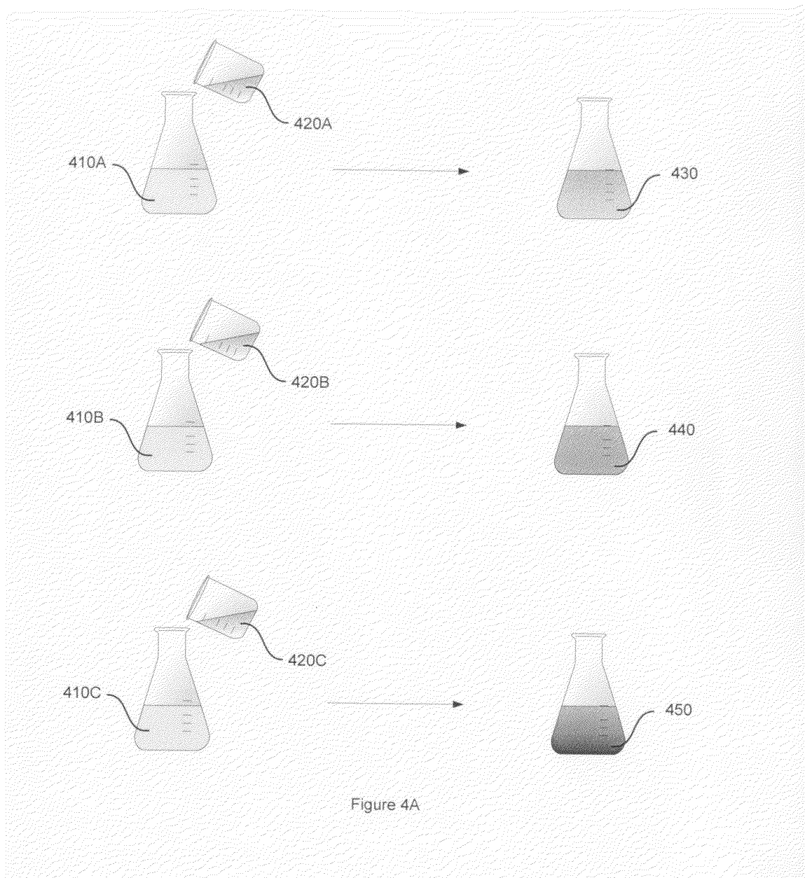

FIG. 3A illustrates UV-visible spectra of AA-BH-AuNPs (301), BH-AuNPs (302) and AA-AuNPs (303) in another embodiment of the present disclosure. As shown there, the peaks in 301, 302 and 303 exhibits characteristics of the nanoparticles produced from AA-BH, BH and AA respectively. It is determined that absorption maximum (λₘₐₓ) for AuNPs formed from 302 or 303 alone is in the range of 550-560 nm.

FIG. 3B illustrates UV-visible spectra of AA-BH-AuNPs in another embodiment of the present disclosure. As shown in the FIG. 3B, the absorption maximum (λₘₐₓ) for AuNPs is determined at 518 nm. At this absorption maximum, the average size of the nanoparticles is determined to be 16-20 nm.

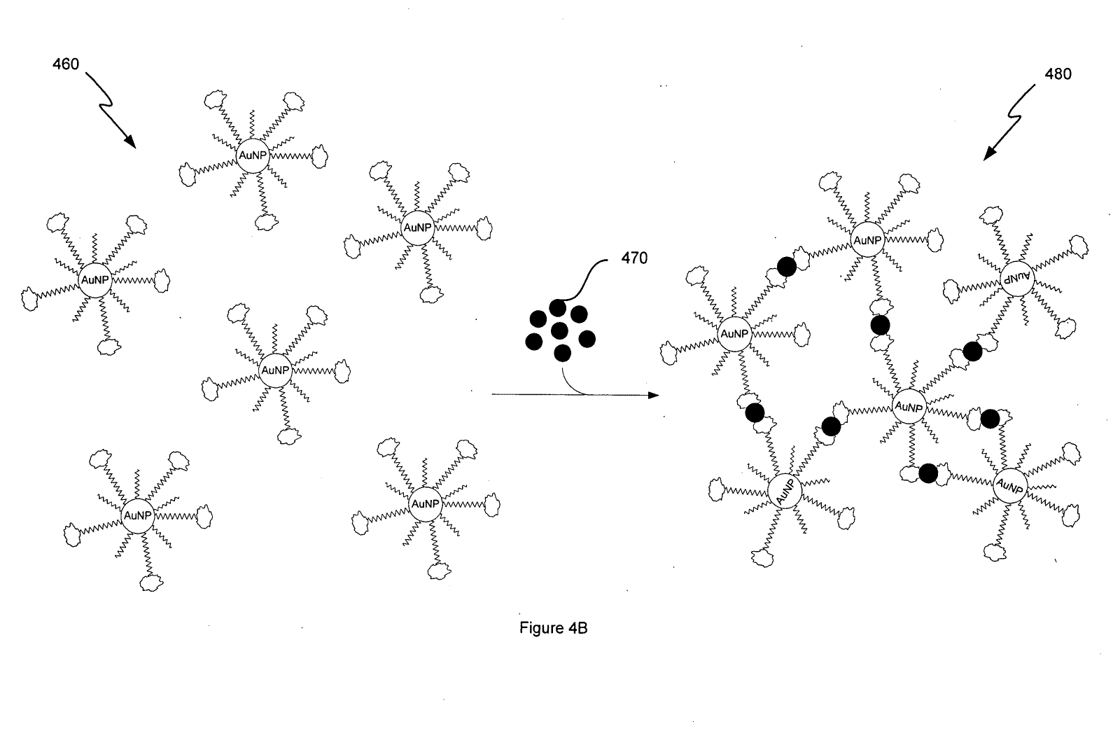

FIG. 4A is a block diagram illustrating visual color change reaction of AuNPs in sensing different substances at different concentrations.

In one embodiment, various test samples comprising of different substances are serially diluted into various concentrations to study the sensitivity of synthesized AuNPs. For example, different substances of varying concentrations like 1 ng to 1000 μg/ml are prepared using serial dilution method.

The varying concentrations of test samples are then used in determining the level of sensitivity of synthesized AuNPs. Around 100 μl of serially diluted metal suspension is mixed with 100 μl of synthesized AuNPs solution and incubated for a predetermined time period for example, 10-30 minutes. After the incubation, a color change reaction is observed from red to blue depending on the concentration of substances present in the test sample solution.

For example, suppose a test sample solution (420) comprising of various substances is serially diluted to varying concentrations say 420A, 420B and 420C respectively. Prepare colloidal AuNPs solution (410) as discussed in FIG. 1B and make 3 volumes (410A, 410B and 410C) of each having 100 μl of the AuNPs solution. After serial dilution, 100 μl of each 420A, 420B and 420C are taken separately and mixed with 3 volumes (410A, 410B and 410C) of the colloidal AuNPs solution.

The AuNPs solutions (410A, 410B and 410C) with the test sample solutions (420A, 420B and 420C) are incubated for a predetermined time period for example, 10-30 minutes wherein the color change reaction takes place. The color of the AuNPs solution changes from red (430) to violet to purple (440) to blue (450) based on the concentration of substances present in the solution.

The visual color change reaction indicates the concentration of substances present in the test sample. The color change from red to violet to purple to blue indicates the increase in concentration of the substances. For example, if 420A contains negligible or less number of substances and 420C has more number of substances, the visual color change for 420A may be ranges to violet to purple whereas for 420C is blue depending on the concentration of substances.

In another embodiment of the present disclosure, the synthesized AuNPs are highly sensitive in detecting minimal concentrations of substances compared to the conventional AuNPs. They are able to sense broad spectrum of toxic or non toxic substances. Using the synthesized AuNPs, the lowest concentration of sensitivity achieved for metals is 5 ppb and for others substances is >50 ppb. The AuNPs have more sensitivity for metals at the range of 5-10 ppb using UV-visible spectrophotometer.

Further, the synthesized AuNPs are used in determining real time water quality assurance and cleanliness of laboratory glassware assurance. They are used to sense the substances at room temperature and require only 10-20 μl of test samples for detection. Using these AuNPs, concentration dependent quick response is observed for several substances. For most of the substances, the sensitivity time is less than 5 seconds if the concentration is more than 1 ppm and that may exceed more than 10 minutes if the substance level is below 1 ppm.

Thus AuNPs are used as real-time sensors in detecting minimal concentration of substances present in a solution with the help of a visual color change reaction and UV-visible spectrophotometer.

FIG. 4B is a schematic diagram illustrating the mechanism of visual color change of AuNPs in sensitivity test.

Upon addition of a test sample solution to the synthesized AuNPs, visual color of the nanoparticles changes from ranges of red to violet to purple to blue. The concentration of substances present in a test sample is one of the reasons behind the change in color of the AuNPs solution. The change in vibrant color of AuNPs is mainly due to its size, shape, state of assembly and peripheral environment in the solution. The fundamental principle behind the color change behavior of the AuNPs is a unique phenomenon called Surface Plasmon Resonance (SPR).

The SPR is a resonant oscillation of conduction electrons at an interface between a negative and positive permitivity material stimulated by incident light. SPR is the basis for measuring adsorption of a material onto the surface of AuNPs.

As substance (470) present in the solution comes in contact with the AuNPs (460), the capping agent of the AuNPs at peripheral end binds to it (470). Similarly, other AuNPs also bind to the same or other substances as shown. This assembles all the AuNPs together causing a visible change in color due to the SPR phenomena. The aggregation (480) of all the AuNPs together increases their size and settles down the solution exhibiting a visible color change. The color change of the AuNPs is simply because of the change in manner of their assembly along with the substances.

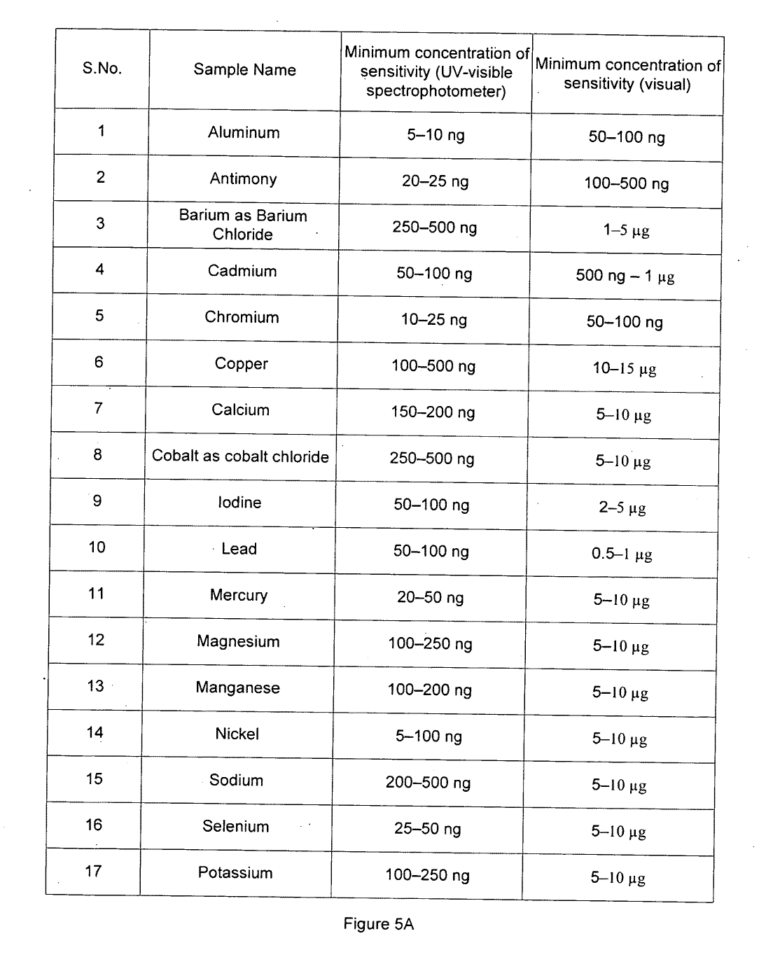

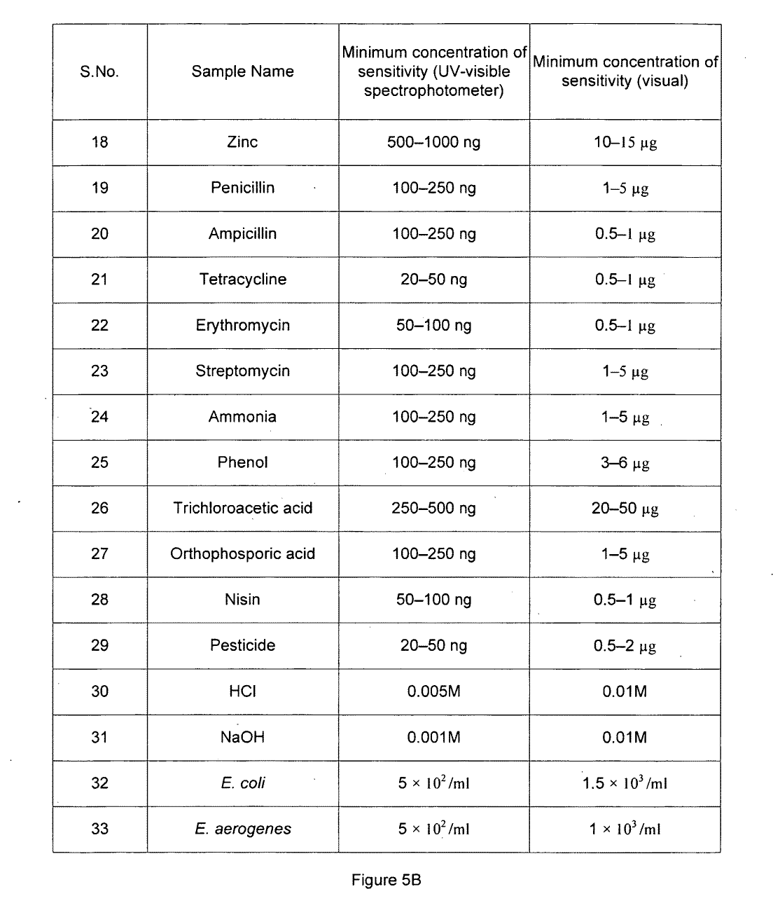

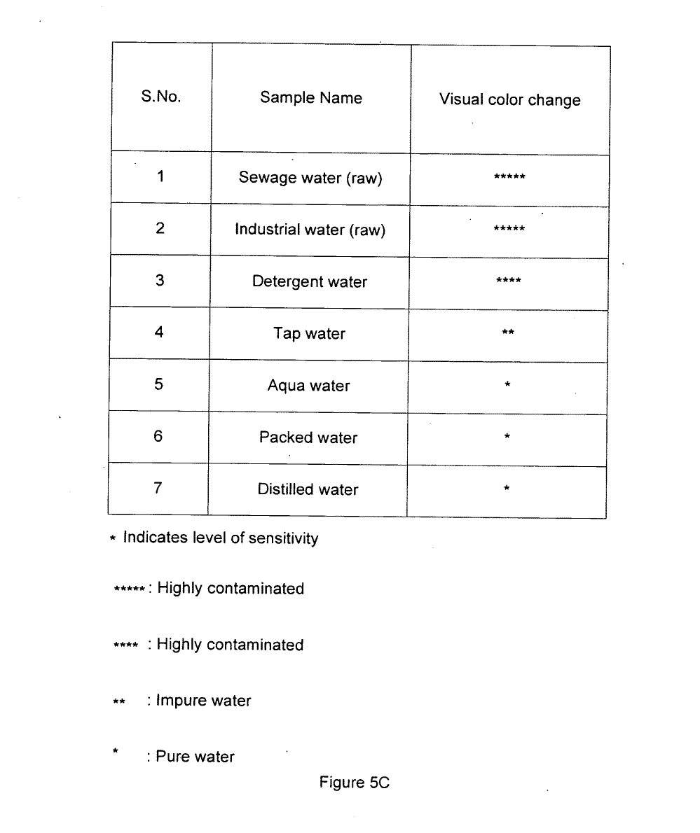

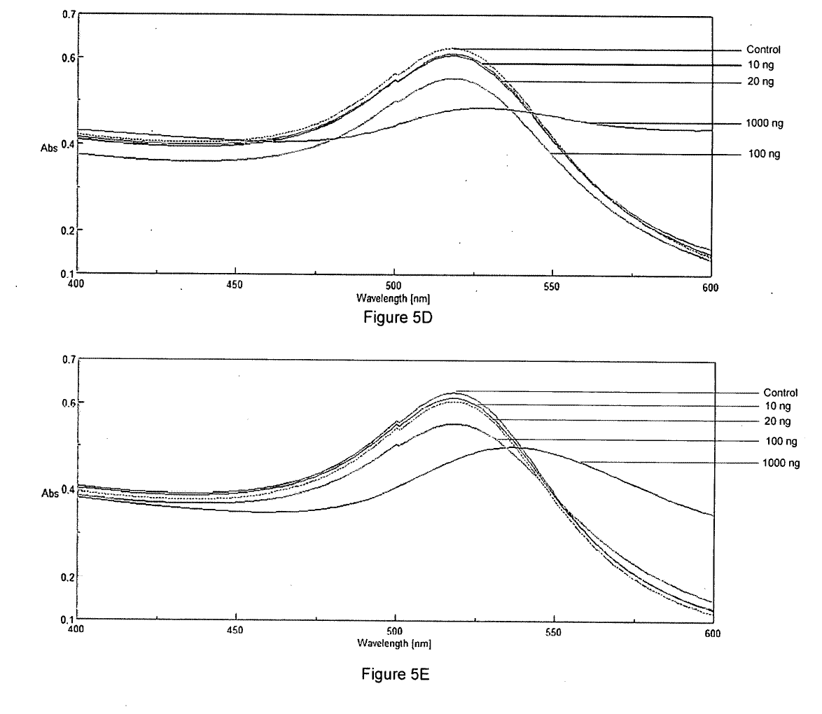

FIGS. 5A through FIG. 5C are the tables illustrating sensitivity of synthesized AuNPs against different substances in another embodiment of the present disclosure.

The AuNPs that are synthesized by using the method as discussed with reference to FIG. 1B, enables sensing or detection of extremely small amounts of substances in the range of a ppb to ppm. These AuNPs further provide broader sensitivity for most of the substances.

The minimum concentration of sensitivity for different substances is determined and tabulated with the help of a visual color change reaction and UV-visible spectrophotometer.

From the tables, it is determined that the lowest concentration of sensitivity achieved for metals is 5 ng and for other substances is >50 ng using the synthesized AuNPs. In sensitivity tests, concentration dependent quick response is observed for several toxicants and impurities.

In one embodiment, the AuNPs exhibit more sensitivity for metals at a range of 5-10 ng in UV visible spectrophotometer and at 100 ng for visual color change. Further, the visual color changes for several molecules including solvents and proteins are observed at >100 ng.

FIGS. 5D and 5E are UV-visible spectra of AuNPs further depicting sensitivity of AuNPs in another embodiment of the present disclosure.

In one embodiment, the sensitivity of synthesized AuNPs for lower concentration of substances for example, aluminum and selenium is determined. FIG. 5D illustrates the sensitivity of AuNPs (as described with reference to FIG. 1B) to the aluminum. As shown there, absorption maximum (λₘₐₓ) is determined for the control without aluminum vs with aluminum at different concentrations. For example, to the AuNPs, an increasing concentration of 10 ng, 20 ng, 100 ng and 1000 ng aluminum is added gradually and λₘₐₓ is determined for each concentration.

FIG. 5E illustrates the sensitivity of AuNPs (as described with reference to FIG. 1B) to the selenium. An increasing concentration of selenium (say 10 ng, 20 ng, 100 ng and 1000 ng) is added to the AuNPs and λₘₐₓ is determined for each concentration as discussed in the FIG. 5D. As the concentrations of aluminum or selenium increases, λₘₐₓ shifts towards higher wavelength which indicates the sensitivity of AuNPs in detecting lower concentration of substances.

While various embodiments of the present disclosure have been described above, it should be understood that they have been presented by way of example only, and not limitation. Thus, the breadth and scope of the present disclosure should not be limited by any of the above-discussed embodiments, but should be defined only in accordance with the following claims and their equivalents.

1. A medium comprising:
a gold nanoparticles (AuNPs); and a pre bonded ascorbic acid and sodium borohydride (AA-BH) capped onto larger number of the AuNPs in the medium, wherein the pre bonded AA-BH prevents aggregation of the AuNPs in the medium.

2. The medium of claim 1, wherein the AuNPs are reduced from a chloroauric acid (HAuCl₄) by the pre bonded AA-BH in the medium.

3. The medium of claim 1, wherein the AuNPs in the medium. exhibiting a highest infrared light absorption characteristic at wave number 3445 cm⁻¹.

4. The medium of claim 3, wherein the AuNPs in the medium exhibiting a prominent infrared light absorption characteristics at wave numbers 2929, 1628, 1622., 1123, 1025, 808 and 680 cm⁻¹.

5. The medium of claim 1, wherein the AuNPs are of size in the range of 16-20 nm.

6. A method comprising,
preparing a solution of ascorbic acid (AA) and sodium borohydride (BH);
mixing the solution to 1.5×10⁻³ M chloroauric acid (HAuCl₄); and
synthesizing larger number of AuNPs capped only with element formed by bonding of AA and BH.

7. The method of claim 6, further comprising:
synthesizing AuNPs capped only with at least one of AA, BH and an element formed by bonding of AA and BH, wherein the solution reduces the HAuCl₄ to AuNPs further capping the reduced AuNPs with at least one of AA, BH and AA-BH.

8. The method of claim 6, wherein the solution is prepared by mixing 56×10⁻³ M of AA and 1.321×10⁻¹ M of BB in deionized water.

9. The method of claim 8, wherein the AA concentration may vary from 5.6×10⁻⁴ M to 56×10⁻² M and the BH concentration may vary from 1.321×10⁻² M to 3.321×1.0⁻²M.

10. A solution for detecting the presence of an impurity, wherein the solution comprising:
a gold nanoparticles (AuNPs); and a pre bonded ascorbic acid and sodium borohydride (AA-BH) wherein the AA-BH are capped onto larger number of the AuNPs in the solution preventing aggregation of the AuNPs in the solution.

11. The solution of claim 10, wherein the solution exhibiting a highest infrared light absorption characteristic at wave number 3445 cm⁻¹.

12. The solution of claim 10, wherein the solution exhibiting a prominent infrared light absorption characteristics at wave numbers 2929, 1628, 1622, 1123, 1025, 808 and 680 cm⁻¹.

13. The solution of claim 10, wherein the AuNPs are of size in the range of 16-20 nm.

14. The solution of claim 10, where in at least forty percent of AuNPs in the solution are capped with (AA-BH).

15. The solution of claim 10, wherein the solution detecting presence of at least 5 ng impurity in a liquid.
